(19) United States
(12) Patent Application Publication
(10) Pub. No.: US 2023/0042542 A1
(43) Pub. Date: Feb. 9, 2023

(54) Scratch-Off Ticket

(71) Applicant: Kenneth Nathaniel Brown, South Holland, IL (US)

(72) Inventor: Kenneth Nathaniel Brown, South Holland, IL (US)

(21) Appl. No.: 17/444,385

(22) Filed: Aug. 3, 2021

(51) Int. Cl. G07F 17/32

(52) U.S. Cl. CPC G07F 17/329; G07F 17/3267

(57) ABSTRACT

The method of playing a scratch-off gaming ticket. Each ticket consists of scratching and revealing license plate numbers. License plate numbers revealed will be used to match the license plate numbers in the play area, which will determine the prize shown in the prize legend.

### FIELD OF THE INVENTION

The present invention generally relates to recreational and gambling devices. More specifically, the present invention provides a scratch-off ticket that provides a novel and unique scratch-off design.

### BACKGROUND OF THE INVENTION

The present invention provides a novel and unique scratch-off ticket design. The present invention, preferably referred to as the Bless-A-Plate scratch-off, provides a novel scratch-off design that consists of matching license plate numbers in one area to win a prize shown in a game highlights grid. The more matched numbers are revealed, the more prize money is won. The Bless-A-Plate scratch-off is unique because of the use of license plate numbers.

In a preferred embodiment, the present invention provides multiple prize amounts such as a $20,000 prize which can be won up to 20 times per player. The Bless-A-Plate scratch-off ticket can be sold at two dollars per ticket and uses a count-up instant win. In other words, the user counts the number of winning plate numbers in the play area and wins the corresponding prize shown in the prize legend. Additional features are further discussed in the sections below.

### BRIEF DESCRIPTION OF THE DRAWINGS

FIG. 1 is an illustration of the present invention showing the preferred embodiment of the scratch-off ticket.

FIG. 2 is an illustration of the present invention showing the preferred embodiment of the scratch-off ticket.

### DETAIL DESCRIPTIONS OF THE INVENTION

All illustrations of the drawings are for the purpose of describing selected versions of the present invention and are not intended to limit the scope of the present invention.

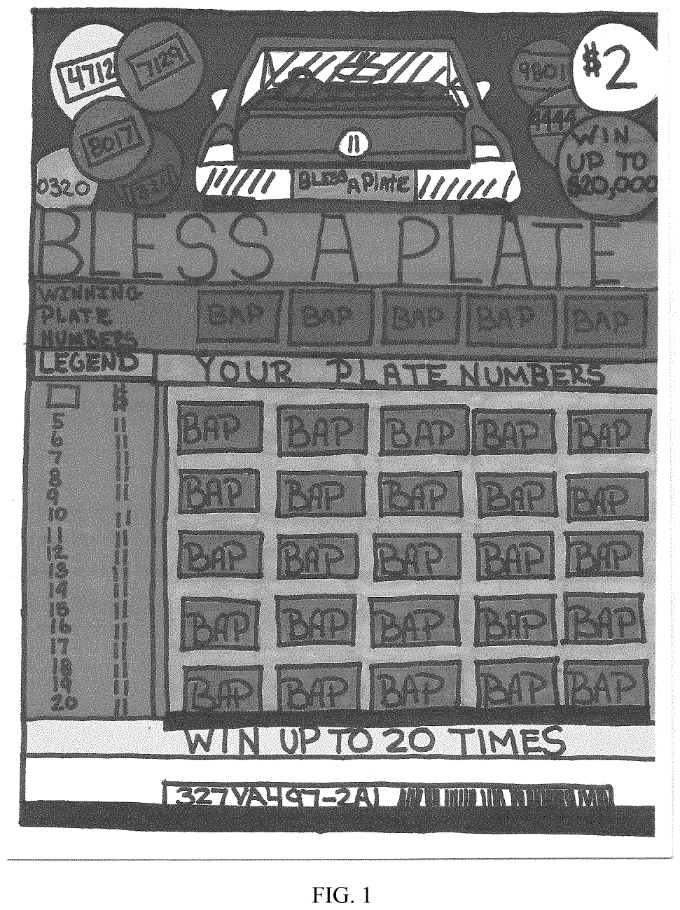

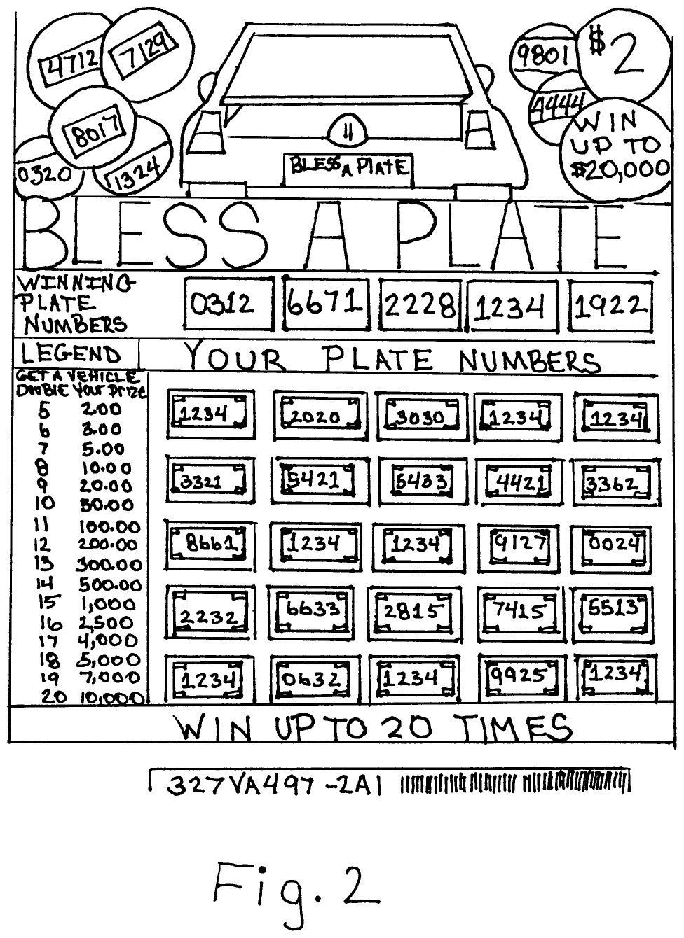

The present invention provides a scratch-off ticket. The scratch-off ticket, also referred to as the Bless-A-Plate scratch-off, provides a novel scratch-off design that facilitates the winning process with vehicle related graphics. In the preferred embodiment, the scratch-off ticket comprises a ticket body with a first surface and a second surface. As can be seen in FIG. 1-2, the ticket body is a thin structure with an overall polygon shape such as a rectangular shape. The ticket body can be made from different materials including, but not limited to, paper, plastic, recycled materials, etc. The first surface is provided opposite to the second surface about the ticket body. As can be seen in FIG. 1-2, the first surface preferably corresponds to the front surface of the ticket body comprising the scratching areas. The second surface corresponds to the rear surface of the ticket body and may comprise various information regarding the scratch-off prices and other legal material. In alternate embodiments, the ticket body can comprise a different ornamental design matching the vehicle theme of the present invention or other non-vehicular designs.

In the preferred embodiment, the first surface is divided into multiple areas that disclose different information regarding the prices and other related information. As can be seen in FIG. 1-2, the first surface comprises a header, a first price area, a second price area, a scratch-off area, and an information area. The header is provided on the top section of the ticket body and preferably comprises various ornamental graphics, a logo, and a title. As can be seen in FIG. 1-2, the various ornamental graphics can include different license plates, a vehicle, as well as other price information. The logo and the tile can be provided in the center of the header or blended in with the various ornamental graphics. In alternate embodiments, the header can be modified to accommodate other information regarding the prices of the scratch-off.

As can be seen in FIG. 1-2, the first price area is preferably positioned under the header and preferably covering the width of the ticket body. The first price area comprises various information including, but not limited to, the winning plate numbers and indicia indicating the winning plate numbers. As can be seen in FIG. 1-2, the winning plate numbers are preferably shown in a linear arrangement across the first price area. The number of winning plate numbers preferably correspond to five winning numbers but can also comprise a different number of license plates. Each winning plate number is provided within a miniature winning plate with a size large enough to fit the winning plate number but small enough fit within the first price area. As can be seen in FIG. 1-2, each winning plate number can be covered in scratchable material that can be easily removed using a nail or an accessible object such as a coin. Further, the scratchable material matches the shape and size of the individual license plate. In alternate embodiments, the first price area can be modified to accommodate other price information.

In the preferred embodiment, the second price area and the scratch-off area are positioned under the first price area. As can be seen in FIG. 1-2, the second price area and the scratch-off area are distributed across the width of the ticket body and positioned adjacent to each other. The second price area preferably includes price information. As can be seen in FIG. 1-2, the price information is displayed in a vertical column arrangement with the number of matches in one column and the corresponding price in an adjacent column. In the preferred embodiment, the first price area comprises a width smaller than the width of the scratch-off area. As can be seen in FIG. 1-2, the scratch-off area comprises a plurality of license plates distributed about the scratch-off area. Each license plate of the plurality of license plates comprises a license plate number, and the total number of license plates is twenty plates. As can be seen in FIG. 2, the license plate numbers on the plurality of license plates can include one or more license plate numbers of the winning license plate numbers shown in the first price area. Further, the winning plate numbers can be repeated multiple times. As can be seen in FIG. 1, each of the license plates of the plurality of license plates in the scratch-off area is covered by scratchable material. The scratchable material can be the same as the scratchable material used in the first price area. Further, the scratchable material can include additional protection material to prevent scams. In alternate embodiments, the scratch-off area and the second price area can be modified to accommodate other information or scratchable areas. Further, the scratch-off area can include a different number of license plate numbers matching a different number of possible prices.

Finally, as can be seen in FIG. 1-2, the information area is provided on the bottom section of the ticket body. The information area is provided below the second price area and the scratch-off area. Further, the information preferably covers the width of the ticket body. The information area preferably includes various information regarding the scratch-off ticket that can be used for verification or validation purposes. As can be seen in FIG. 1-2, the information area can further include other information such as price information or game information for the user to utilize when playing the present invention. In alternate embodiments, the present invention can be modified to use different themes or to provide other promotional features.

Although the invention has been explained in relation to its preferred embodiment, it is to be understood that many other possible modifications and variations can be made without departing from the spirit and scope of the invention.

1. Scratch off ticket consist of matching license plate numbers to win a prize
The present invention provides multiple prize amounts such as a $20,000 prize which can be won up to 20 times per player.
The more matched numbers are revealed, the more prize money is won
Prizes are shown in the game's highlighted grid.
